(19) United States
(12) Patent Application Publication
(10) Pub. No.: US 2021/0317386 A1
(43) Pub. Date: Oct. 14, 2021

(54) POLYCARBOXYLIC ACID COPOLYMER

(71) Applicant: NIPPON SHOKUBAI CO., LTD., Osaka-shi, Osaka (JP)

(72) Inventors: Takako HARIGAE, Osaka (JP); Yoshikazu TOMIKE, Osaka (JP)

(21) Appl. No.: 17/265,104

(22) PCT Filed: Aug. 2, 2019
(86) PCT No.: PCT/JP2019/030406

§ 371 Date: Feb. 1, 2021

(30) Foreign Application Priority Data
Aug. 3, 2018 (JP) 2018-146873

(51) Int. Cl. C11D 3/37; C08F 220/28

(52) U.S. Cl. CPC C11D 3/3765; C08F 220/286

(57) ABSTRACT

Provided is a polymer capable of more sufficiently achieving the miscibility with surfactants and the effects of enhancing the surface tension-reducing ability of surfactants than conventional polymers used in detergent applications. The present invention relates to a polycarboxylic acid copolymer used in liquid detergent applications, the polycarboxylic acid copolymer containing: a structural unit (a) derived from a polyalkylene glycol monomer (A) represented by the following formula (1), a structural unit (b) derived from a polyalkylene glycol monomer (B) represented by the following formula (2), a structural unit (c) derived from an unsaturated carboxylic acid monomer (C). The monomers (A) and (B) satisfy n−m≥3

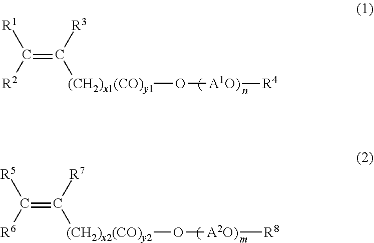

### TECHNICAL FIELD

The present invention relates to polycarboxylic acid copolymers. Specifically, the present invention relates to a polycarboxylic acid copolymer useful in liquid detergent applications.

### BACKGROUND ART

Polycarboxylic acid copolymers are used in various applications such as dispersants, admixtures for cement, water treatment chemicals, and scale inhibitors. Polycarboxylic acid copolymer-containing admixtures for cement are used as agents such as water-reducing agents to increase the fluidity of cement compositions and reduce the water content of the cement compositions. Thereby, cured products having enhanced properties such as strength and durability are provided. For example, Patent Literature 1 discloses a copolymer composition for admixtures for cement containing three, first to third, polycarboxylic acid copolymers having specific structures. The first to third polycarboxylic acid copolymers are present in the composition in a ratio by mass of first polycarboxylic acid copolymer/second polycarboxylic acid copolymer/third polycarboxylic acid copolymer of (15 to 70)/(5 to 60)/(15 to 60) based on total 100% by mass of these copolymers. Patent Literatures 2 to 4 disclose polycarboxylic acid copolymers used in applications for admixtures for cement.

In recent years, polycarboxylic acid copolymers have been used as detergent builders in detergents such as laundry detergents and dishwashing detergents. For example, Patent Literature 5 discloses a phosphate-free detergent preparation for machine dishwashing containing the following components a) to g) in a total amount of up to 100% by mass: a) a copolymer in an amount of 1 to 20% by mass containing a1) 50 to 99.5 mol % of a monoethylenically unsaturated monocarboxylic acid and/or a salt thereof, a2) 0.5 to 20 mol % of an alkoxylated monoethylenically unsaturated monomer represented by a predetermined structure, a3) 0 to 50 mol % of monoethylenically unsaturated dicarboxylic acid, an anhydride thereof, and/or a salt thereof, and a4) 0 to 20 mol % of a different copolymerizable monoethylenically unsaturated monomer, the copolymer having an average molecular weight Mw of 30000 to 500000 g/mol and a K value of 40 to 150 that is measured in an aqueous solution having a copolymer concentration of 1% by mass and a pH of 7 at 25° C.; b) a complexing agent in an amount of 1 to 50% by mass selected from the group consisting of nitrilotriacetic acid, ethylenediaminetetraacetic acid, diethylenetriaminepentaacetic acid, hydroxyethylethylenediaminetriacetic acid, glycine-N,N-diacetic acid, and derivatives thereof, glutamic acid-N,N-diacetate, iminodisuccinate, hydroxyiminodisuccinate, S,S-ethylenediaminedisuccinate, aspartate diacetic acid, and salts thereof; c) a low foam nonionic surfactant in an amount of 1 to 15% by mass; d) a bleaching agent and optionally a bleaching activator in an amount of 0.1 to 30% by mass; e) a different builder in an amount of 0 to 60% by mass; f) an enzyme in an amount of 0 to 8% by mass; and g) one or more different additives in an amount of 0 to 50% by mass, such as an anionic or zwitterionic surfactant, a bleaching catalyst, an alkali support, a corrosion inhibitor, a defoamer, a dye, a fragrance agent, a filler, an organic solvent, and water.

Common detergents contain surfactants. The surfactants reduce the surface tension, promoting wetting of items to be washed such as fibers, in use of detergents and increasing the detergency. Polymers used in detergent applications need to have an ability to effectively enhance the cleaning function of surfactants to enhance the detergency. In addition, in recent years, the use of liquid detergents has increased due to the spread of drum-type washing machines, for example. In response to this, various detergent builders are required to have not only detergency against stains, but also sufficient miscibility with surfactants so that they can be blended with liquid detergents. In particular, recent market trends show that highly concentrated (low water content) liquid detergents are preferred, and consumers prefer non-turbid and highly transparent liquid detergents. Thus, miscibility with other liquid detergent components such as surfactants has been required more strictly than before.

### CITATION LIST

### Patent Literature

Patent Literature 1: JP 2009-506184 T
Patent Literature 2: JP 2011-256064 A
Patent Literature 3: JP H09-286645 A
Patent Literature 4: JP H09-286646 A
Patent Literature 5: JP 2001-233955 A

### SUMMARY OF INVENTION

### Technical Problem

As described above, various polymers for detergent applications have been developed. Conventional polymers for detergent applications however have insufficient performance in terms of miscibility with surfactants and promotion of the surface tension-reducing ability of surfactants. Thus, the conventional polymers have room for improvement.

The present invention has been made in view of such a current state of the art and aims to provide a polymer capable of more sufficiently achieving the miscibility with surfactants and the effects of enhancing the surface tension-reducing ability of surfactants than conventional polymers used in detergent applications.

### Solution to Problem

The present inventors have conducted studies on various polymers used in detergent applications and found that a copolymer containing structural units derived from two polyalkylene glycol monomers having different average numbers of moles of oxyalkylene groups added and a structural unit derived from an unsaturated carboxylic acid monomer can sufficiently achieve the miscibility with surfactants and the effects of enhancing the surface tension-reducing ability of surfactants. Thereby, the present inventors have arrived at the solution to the above problem, completing the present invention.

In other words, the present invention relates to a polycarboxylic acid copolymer used in liquid detergent applications, the polycarboxylic acid copolymer containing:

a structural unit (a) derived from a polyalkylene glycol monomer (A) represented by the following formula (1):

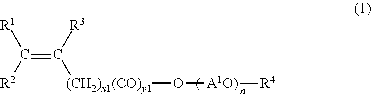

wherein R¹, R², and R³ are the same as or different from each other and are each a hydrogen atom or a methyl group; R⁴ is a hydrogen atom or a C1-C30 hydrocarbon group; A¹Os are the same as or different from each other and are each an oxyalkylene group; n is the average number of moles of oxyalkylene groups added and is a number of 4 to 100; x1 is a number of 0 to 4; and y1 is 0 or 1;

a structural unit (b) derived from a polyalkylene glycol monomer (B) represented by the following formula (2):

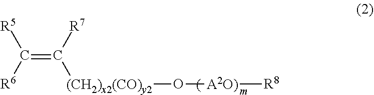

wherein R⁵, R⁶, and R⁷ are the same as or different from each other and are each a hydrogen atom or a methyl group; R⁸ is a hydrogen atom or a C1-C30 hydrocarbon group; A²Os are the same as or different from each other and are each an oxyalkylene group; m is the average number of moles of oxyalkylene groups added and is a number of 1 to 97; x2 is a number of 0 to 4; and y2 is 0 or 1; and

a structural unit (c) derived from an unsaturated carboxylic acid monomer (C),

the monomers (A) and (B) satisfying n−m≥3.

Preferably, in the copolymer, the structural unit (a) is present in a proportion of 5 to 90% by mass based on 100% by mass of all structural units.

Preferably, in the copolymer, the structural unit (b) is present in a proportion of 5 to 90% by mass based on 100% by mass of all structural units.

Preferably, in the copolymer, the structural units (a) and (b) are present in a total proportion of 50 to 88% by mass based on 100% by mass of all structural units.

Preferably, in the copolymer, the structural unit (c) is present in a proportion of 18 to 50% by mass based on 100% by mass of all structural units.

Preferably, in the copolymer, the structural unit (c) is present in a proportion of 20 to 39% by mass based on 100% by mass of all structural units.

Preferably, in the copolymer, the unsaturated carboxylic acid monomer (C) is (meth)acrylic acid or a salt thereof, maleic acid or a salt thereof, or maleic anhydride.

Preferably, in the copolymer, n in the formula (1) for the monomer (A) is 5 to 100.

Preferably, in the copolymer, m in the formula (2) for the monomer (B) is 2 to 97.

Preferably, the copolymer has a weight average molecular weight of 5000 to 100000.

The present invention also relates to an additive for liquid detergents, containing the polycarboxylic acid copolymer.

The present invention also relates to a liquid detergent composition containing:

the polycarboxylic acid copolymer; and

a detergent additive other than the copolymer.

The present invention also relates to a method of producing a liquid detergent composition, the method including adding the polycarboxylic acid copolymer to a detergent additive other than the copolymer.

The present invention also relates to a method of using the polycarboxylic acid copolymer as an additive for liquid detergents.

### Advantageous Effects of Invention

The polycarboxylic acid copolymer of the present invention having the above features is superior to conventional polymers used in detergent applications in that the polycarboxylic acid copolymer can sufficiently achieve the miscibility with surfactants and the effects of enhancing the surface tension-reducing ability of surfactants. Thus, the polycarboxylic acid copolymer of the present invention can be suitably used in liquid detergent applications.

### DESCRIPTION OF EMBODIMENTS

The following description is offered to specifically illustrate preferred embodiments of the present invention. It should be noted that the present invention is not limited only to these embodiments, and the embodiments may be appropriately altered within the scope of the present invention. Any combination of two or more of the following preferred embodiments of the present invention is also a preferred embodiment of the present invention.

<Polycarboxylic Acid Copolymer>

The polycarboxylic acid copolymer of the present invention (hereinafter, also referred to as the copolymer of the present invention) contains a structural unit (a) derived from a polyalkylene glycol monomer (A) represented by the formula (1), a structural unit (b) derived from a polyalkylene glycol monomer (B) represented by the formula (2), and a structural unit (c) derived from an unsaturated carboxylic acid monomer (C).

The polycarboxylic acid copolymer of the present invention is a copolymer of two polyalkylene glycol monomers having different average polyalkylene glycol chain lengths. The presence of structural units derived from two polyalkylene glycol monomers having different average polyalkylene glycol chain lengths leads to excellent adsorption to a variety of stains and enhanced detergency.

In the copolymer, the structural unit (a) is preferably present in a proportion of 5 to 90% by mass, more preferably 5 to 70% by mass, still more preferably 10 to 65% by mass, particularly preferably 20 to 60% by mass, based on 100% by mass of all structural units.

In the copolymer, the structural unit (b) is preferably present in a proportion of 5 to 90% by mass, more preferably 5 to 70% by mass, still more preferably 10 to 65% by mass, particularly preferably 20 to 60% by mass, based on 100% by mass of all structural units.

In the copolymer, the structural units (a) and (b) are preferably present in a total proportion of 50 to 88% by mass, more preferably 61 to 80% by mass, still more preferably 62 to 80% by mass, particularly preferably 64 to 75% by mass, based on 100% by mass of all structural units.

The polymer preferably has a ratio of (a) to (b), (a)/(b), of 0.056 to 18, more preferably 0.07 to 14, still more preferably 0.15 to 6.5, particularly preferably 0.16 to 6.

In the copolymer, the structural unit (c) is preferably present in a proportion of 18 to 50% by mass based on 100% by mass of all structural units. Such a copolymer of the present invention achieves much better miscibility with surfactants. The proportion of the structural unit (c) is more preferably 20 to 39% by mass, still more preferably 20 to 38% by mass, particularly preferably 20 to 36% by mass.

The copolymer may further contain a structural unit (e) derived from a monomer (E) other than the monomer (A), monomer (B), and unsaturated carboxylic acid monomer (C).

In the copolymer, the structural unit (e) is preferably present in a proportion of 0 to 10% by mass based on 100% by mass of all structural units.

The proportion is more preferably 0 to 8% by mass, still more preferably 0 to 5% by mass, most preferably 0% by mass.

When the amounts of the monomers used to produce the copolymer are known, the proportions of the structural units in the polycarboxylic acid copolymer can be determined by analyzing the percentages of the monomers consumed in the polymerization reaction by liquid chromatography (LC). Here, all the consumed monomers are considered as being converted into the copolymer by the polymerization reaction.

When the amounts of the monomers used to produce the copolymer are unknown, the proportions of the structural units can be determined by any of various structural analysis techniques (e.g., NMR).

When the copolymer contains a structural unit containing a salt of a carboxyl group, the mass of the structural unit is determined as the mass of the structural unit in the form of the corresponding acid.

The copolymer of the present invention preferably has a weight average molecular weight of 5000 to 100000. The copolymer having a weight average molecular weight of 100000 or smaller achieves much better miscibility.

The weight average molecular weight is more preferably 5000 to 80000, still more preferably 5000 to 70000, particularly preferably 5000 to 60000.

The weight average molecular weight may be measured by the method disclosed in the Examples.

<Polyalkylene Glycol Monomers (A) and (B)>

The polyalkylene glycol monomer (A) is a compound represented by the formula (1), the polyalkylene glycol monomer (B) is a compound represented by the formula (2), and n and m in the formulas (1) and (2) satisfy n−m≥3.

The copolymer of the present invention containing structural units derived from two polyalkylene glycol monomers having different average polyalkylene glycol chain lengths can sufficiently achieve the miscibility with surfactants and the effects of enhancing the surface tension-reducing ability of surfactants. Thus, the copolymer of the present invention can be suitably used in liquid detergent applications. The copolymer of the present invention containing such structural units can increase the speed of permeation of washing water into clothes and the like. Thereby, the washing time can be shortened.

In the formula (1), A¹Os “are the same as or different from each other”, and are each an oxyalkylene group. This means that n oxyalkylene groups A¹Os in the polyalkylene glycol may all be the same as or may be different from each other. The carbon number of the oxyalkylene group is preferably 2 to 18, more preferably 2 to 10, still more preferably 2 to 8, particularly preferably 2 to 4.

In the formula (1), the oxyalkylene group represented by A¹O is an adduct with an alkylene oxide. Examples of the alkylene oxide include C2-C8 alkylene oxides such as ethylene oxide, propylene oxide, butylene oxide, isobutylene oxide, 1-butene oxide, 2-butene oxide, and styrene oxide. Preferred are C2-C4 alkylene oxides such as ethylene oxide, propylene oxide, and butylene oxide, with ethylene oxide and propylene oxide being more preferred.

When the polyalkylene glycol is an adduct with two or more alkylene oxides selected from the group consisting of ethylene oxide, propylene oxide, butylene oxide, and styrene oxide, the oxides may be added by any addition form such as random addition, block addition, or alternating addition. To balance the hydrophilicity and the hydrophobicity, the oxyalkylene groups in the polyalkylene glycol preferably include oxyethylene groups as an essential component. The oxyethylene groups more preferably constitute 50 mol % or more of the oxyalkylene groups, still more preferably constitute 90 mol % or more of the oxyalkylene groups.

Specific examples and preferred examples of the oxyalkylene group represented by A²O in the formula (2) are the same as those of A¹O in the formula (1).

In the formula (1), n is the average number of moles of oxyalkylene groups added and is 4 to 100. This enables the copolymer of the present invention to achieve excellent miscibility with surfactants. Preferably, n is 5 to 95, more preferably 6 to 90, still more preferably 8 to 85, particularly preferably 10 to 80, further preferably 12 to 75, further more preferably 15 to 70.

In the formula (2), m is the average number of moles of oxyalkylene groups added and is 1 to 97. This enables the copolymer of the present invention to achieve excellent miscibility with surfactants. Preferably, m is 2 to 92, more preferably 3 to 87, still more preferably 3 to 82, particularly preferably 3 to 77, further preferably 3 to 72, further more preferably 4 to 67.

In a preferred embodiment of the present invention, in the copolymer of the present invention, n in the formula (1) for the monomer (A) falls within the range of 5 to 100, and m in the formula (2) for the monomer (B) falls within the range of 2 to 97.

The n and m satisfy n−m≥3, preferably n−m≥4. This can more sufficiently achieve the effects of the present invention. The n and m more preferably satisfy n−m≥5, still more preferably n−m≥8, further preferably n−m≥10, particularly preferably n−m≥12.

R¹ to R³ in the formula (1) are the same as or different from each other, and R⁵ to R⁷ in the formula (2) are the same as or different from each other. They are each a hydrogen atom or a methyl group. Preferably, R¹ and R² are hydrogen atoms, and R³ is a hydrogen atom or a methyl group. More preferably, R¹ and R² are hydrogen atoms, and R³ is a methyl group. Preferably, R⁵ and R⁶ are hydrogen atoms, and R⁷ is a hydrogen atom or a methyl group. More preferably, R⁵ and R⁶ are hydrogen atoms, and R⁷ is a methyl group.

In the formulas (1) and (2), x1 and x2 are each a number of 0 to 4, and y1 and y2 are each 0 or 1. When y1 and y2 are each 0, x1 and x2 are each preferably 1 or 2. In this case, R³ and R⁷ are more preferably methyl groups.

When y1 and y2 are each 1, x1 and x2 are each preferably 0. In this case, R³ and R⁷ are each more preferably a hydrogen atom or a methyl group.

When x1 and x2 are each 0, and y1 and y2 are each 0, A¹O and A²O each directly bonded to the oxygen atom that is attached to the carbon-carbon double bond are preferably oxyalkylene groups each containing four carbon atoms.

The x1 and x2 are each preferably 0. In a preferred embodiment of the present invention, x1 and x2 are each 0 and y1 and y2 are each 1.

R⁴ in the formula (1) and R⁸ in the formula (2) are each a hydrogen atom or a C1-C30 hydrocarbon group, preferably a C1-C20 hydrocarbon group or a hydrogen atom, more preferably a hydrogen atom or a C1-C18 hydrocarbon group, still more preferably a hydrogen atom or a C1-C12 hydrocarbon group, particularly preferably a hydrogen atom or a C1-C8 hydrocarbon group, most preferably a C1-C3 hydrocarbon group.

Examples of the hydrocarbon group include linear or branched alkyl groups such as methyl, ethyl, propyl, isopropyl, n-butyl, isobutyl, sec-butyl, tert-butyl, pentyl, isopentyl, neopentyl, 3-pentyl, hexyl, heptyl, octyl, nonyl, decyl, undecyl, dodecyl, isooctyl, 2,3,5-trimethylhexyl, 4-ethyl-5-methyloctyl, 2-ethylhexyl, tetradecyl, octadecyl, and icosyl groups; cyclic alkyl groups such as cyclopropyl, cyclobutyl, cyclopentyl, cyclohexyl, cycloheptyl, and cyclooctyl groups; and aryl groups such as phenyl, benzyl, phenethyl, o-, m- or p-tolyl, 2,3- or 2,4-xylyl, mesityl, naphthyl, anthryl, phenanthryl, biphenylyl, benzhydryl, trityl, and pyrenyl groups. Preferred among these are linear, branched, or cyclic alkyl groups.

Specific examples of the polyalkylene glycol monomers (A) and (B) include polyalkylene glycol mono(meth)acrylates such as (poly)ethylene glycol mono(meth)acrylate and (poly)propylene glycol mono(meth)acrylate; alkoxy polyalkylene glycol mono(meth)acrylates such as methoxy (poly)ethylene glycol mono(meth)acrylate and methoxy (poly)propylene glycol mono(meth)acrylate; and compounds prepared by adding 1 to 500 mol of an alkylene oxide to vinyl alcohol, (meth)allyl alcohol, 3-methyl-3-buten-1-ol (isoprenol), 3-methyl-2-buten-1-ol, 2-methyl-3-buten-2-ol, 2-methyl-2-buten-1-ol, or 2-methyl-3-buten-1-ol. More preferred are compounds prepared by adding 1 to 500 mol of an alkylene oxide to 3-methyl-3-buten-1-ol (isoprenol) or (meth)allyl alcohol. The “alkylene oxide” in the above examples is preferably ethylene oxide or propylene oxide. Preferred among these are alkoxy polyalkylene glycol mono(meth)acrylates, with alkoxy polyalkylene glycol monomethacrylates being more preferred.

<Unsaturated Carboxylic Acid Monomer (C)>

The unsaturated carboxylic acid monomer (C) may be any monomer containing a carboxyl group and an ethylenically unsaturated hydrocarbon group (unsaturated group). Examples thereof include an unsaturated monocarboxylic acid monomer and an unsaturated dicarboxylic acid monomer.

The unsaturated monocarboxylic acid monomer is a monomer containing one unsaturated group and one group capable of forming a carbanion in a molecule. Examples thereof include acids such as (meth)acrylic acid, crotonic acid, isocrotonic acid, tiglic acid, 3-methylcrotonic acid, 2-methyl-2-pentenoic acid, and α-hydroxyacrylic acid, and monovalent metal salts, divalent metal salts, ammonium salts, and organic amine salts of these acids; a half ester of any of the unsaturated dicarboxylic acid monomers described below and a C1-C22 alcohol or a C2-C4 glycol; and a half amide of any of the unsaturated dicarboxylic acid monomers and a C1-C22 amine. The unsaturated dicarboxylic acid monomer is a monomer containing one unsaturated group and two groups each capable of forming a carbanion in a molecule. Examples thereof include acids such as maleic acid, itaconic acid, mesaconic acid, citraconic acid, and fumaric acid; monovalent metal salts, divalent metal salts, ammonium salts, and organic amine salts of these acids; and anhydrides thereof.

The unsaturated carboxylic acid monomer (C) is preferably (meth)acrylic acid or a salt thereof, maleic acid or a salt thereof, or maleic anhydride, more preferably (meth)acrylic acid or a salt thereof, particularly preferably methacrylic acid or a salt thereof.

The copolymer of the present invention may further contain a structural unit (e) derived from a monomer (E) other than the unsaturated carboxylic acid monomer (A) and the polyalkylene glycol monomer (B).

The monomer (E) may be any monomer copolymerizable with the monomer (A) or (B). Examples thereof include unsaturated sulfonic acids such as 3-(meth)allyloxy-2-hydroxypropanesulfonic acid, 2-(meth)allyloxyethylenesulfonic acid, 2-acrylamido-2-methylprdpanesulfonic acid, p-styrenesulfonic acid, α-methyl-p-styrenesulfonic acid, vinylsulfonic acid, vinylsulfamic acid, (meth)allylsulfonic acid, isoprenesulfonic acid, 4-(allyloxy)benzenesulfonic acid, 1-methyl-2-propene-1-sulfonic acid, 1,1-dimethyl-2-propene-1-sulfonic acid, 3-butene-1-sulfonic acid, 1-butene-3-sulfonic acid, 2-acrylamido-1-methylpropanesulfonic acid, 2-acrylamidepropanesulfonic acid, 2-acrylamido-n-butanesulfonic acid, 2-acrylamido-2-phenylpropanesulfonic acid, and 2-((meth)acryloyloxy)ethanesulfonic acid, and salts thereof; hydroxy group-containing (meth)acrylates such as hydroxyethyl (meth)acrylate and hydroxypropyl (meth)acrylate; hydroxy group-containing ethers such as 3-(meth)allyloxy-1,2-dihydroxypropane and 1-allyloxy-3-butoxypropan-2-ol; N-vinyl lactam monomers such as N-vinylpyrrolidone; (meth)acrylic acid esters such as methyl (meth)acrylate, ethyl (meth)acrylate, propyl (meth)acrylate, butyl (meth)acrylate, cyclohexyl (meth)acrylate, 2-ethylhexyl (meth)acrylate, n-octyl (meth)acrylate, iso-nonyl (meth)acrylate, dodecyl (meth)acrylate, and stearyl (meth)acrylate; polyalkylene glycol (meth)acrylate having a number of moles of alkylene glycol added of 1 to 300, such as ethylene glycol (meth)acrylate; N-substituted or unsubstituted (meth)acrylamides such as (meth)acrylamide, N-monomethyl (meth)acrylamide, N-monoethyl (meth)acrylamide, and N,N-dimethyl (meth)acrylamide; vinyl aryl monomers such as styrene, α-methylstyrene, vinyl toluene, indene, vinylnaphthalene, phenylmaleimide, and vinylaniline; alkenes such as ethylene, propylene, butadiene, isobutylene, and octene; vinyl carboxylates such as vinyl acetate and vinyl propionate; vinyl ethers such as methyl vinyl ether, ethyl vinyl ether, and butyl vinyl ether; vinyl ethylene carbonate and derivatives thereof; unsaturated amines such as N,N-dimethylaminoethyl (meth)acrylate, N,N-dimethylaminoethyl (meth)acrylamide, vinyl pyridine, and vinyl imidazole, and salts and quaternary compounds thereof; and vinyl cyanide monomers such as acrylonitrile and methacrylonitrile.

<Method of Producing Polycarboxylic Acid Copolymer>

The copolymer of the present invention may be produced by any method, and it may be produced by polymerizing a monomer component. Specific examples and preferred examples of the monomer component and preferred proportions of the monomers are those described above.

The method of producing the copolymer preferably includes polymerizing a monomer component containing the polyalkylene glycol monomer (A), the polyalkylene glycol monomer (B), and the unsaturated carboxylic acid monomer (C) (hereinafter, also referred to as “polymerization”).

An aspect of the present invention relates to the method of producing a polycarboxylic acid copolymer.

In the polymerization, polymerizing the monomer component may be started by any technique. Examples of the technique include addition of a polymerization initiator, UV irradiation, application of heat, and light irradiation in the presence of a photopolymerization initiator.

In the polymerization, a polymerization initiator is preferably used.

Preferred examples of the polymerization initiator include hydrogen peroxide; persulfates such as sodium persulfate, potassium persulfate, and ammonium persulfate; azo compounds such as dimethyl-2,2′-azobis(2-methylpropionate), 2,2′-azobis(isobutyronitrile), 2,2′-azobis(2-methylpropionamidine) dihydrochloride (2,2′-azobis-2-amidinopropane dihydrochloride), 2,2′-azobis[N-(2-carboxyethyl)-2-methylpropionamidine] hydrate, 2,2′-azobis[2-(2-imidazolin-2-yl)propane], 2,2′-azobis[2-(2-imidazolin-2-yl)propane] dihydrochloride, and 2,2′-azobis(1-imino-1-pyrrolidino-2-methylpropane) dihydrochloride; organic peroxides such as benzoyl peroxide, lauroyl peroxide, peracetic acid, di-t-butyl peroxide, and cumene hydroperoxide; and redox initiators that generate radicals and are each a combination of an oxidizing agent and a reducing agent, such as a combination of ascorbic acid and hydrogen peroxide or a combination of a persulfate and a metal salt. Preferred among these polymerization initiators are hydrogen peroxide, persulfates, and azo compounds because they tend to reduce the amount of residual monomers. More preferred are persulfates. These polymerization initiators may be used alone, or two or more of these may be used in the form of a mixture.

The amount of the polymerization initiator(s) used is preferably 0.1 g or more and 10 g or less, more preferably 0.2 g or more and 8 g or less, still more preferably 0.3 g or more and 7 g or less, most preferably 0.5 g or more and 5 g or less relative to 100 g of the monomers used (total amount of the polyalkylene glycol monomer (A), polyalkylene glycol monomer (B), unsaturated carboxylic acid monomer (C), and monomer (E) used).

In the polymerization, a chain transfer agent may be used as a molecular weight modifier for the polymer if necessary. Specific examples of the chain transfer agent include mercaptocarboxylic acids such as thioglycolic acid (mercaptoacetic acid), 3-mercaptopropionic acid, 2-mercaptopropionic acid (thiolactic acid), 4-mercaptobutanoic acid, and thiomalic acid, and salts thereof, mercaptoethanol, thioglycerol, and 2-mercaptoethanesulfonic acid; halides such as carbon tetrachloride, methylene chloride, bromoform, and bromotrichloroethane; secondary alcohols such as isopropanol and glycerol; phosphorous acid, hypophosphorous acid, and hypophosphites and hydrates thereof; and hydrogen sulfite and bisulfite and compounds that may generate hydrogen sulfite or bisulfite (e.g., bisulfite, metabisulfite, dithionous acid (dithionite), and sulfurous acid (sulfite)). Preferred among these is a compound containing a mercapto group such as mercaptocarboxylic acid, and more preferred is a mercapto group-containing compound (mercaptocarboxylic acid) containing a carboxyl group.

In the production of the copolymer of the present invention, the chain transfer agent is preferably used in an amount of 0.5 mol % or more and 30 mol % or less, more preferably 0.7 mol % or more and 25 mol % or less, still more preferably 0.8 mol % or more and 20 mol % or less, most preferably 1 mol % or more and 10 mol % or less relative to 100 mol % of the monomers (all of the monomers) used.

In the polymerization, the polymerization temperature is preferably 40° C. or higher and 150° C. or lower, more preferably 50° C. or higher, still more preferably 55° C. or higher. The polymerization temperature is more preferably 120° C. or lower, still more preferably 110° C. or lower.

In the polymerization, the monomer component may be put into a reaction vessel by any technique. Examples of the technique include placing the entire monomer component into the reaction vessel in one portion at the beginning of the reaction; placing the entire monomer component into the reaction vessel in portions or in a continuous manner; and placing part of the monomer component into the reaction vessel at the beginning of the reaction, followed by placing the rest of the monomer component into the reaction vessel in portions or in a continuous manner. The radical polymerization initiator, when used, may be initially put into the reaction vessel, may be added dropwise into the reaction vessel, or may be put into the reaction vessel by combination of these procedures depending on the purpose.

The thus obtained copolymer may be used as it is as a detergent additive such as an additive for liquid detergents. It may be neutralized with an alkaline substance if necessary before use. The alkaline substance is suitably an inorganic salt (e.g., a hydroxide or a carbonate of a monovalent metal or a divalent metal), ammonia, or an organic amine. After the completion of the reaction, the concentration of the copolymer may be controlled if necessary.

<Applications of Copolymer>

The polycarboxylic acid copolymer of the present invention is used in liquid detergent applications.

In other words, the present invention also relates to an additive for liquid detergents, containing the polycarboxylic acid copolymer. The present invention also relates to a method of using the polycarboxylic acid copolymer as an additive for liquid detergents.

The present invention also relates to a liquid detergent composition containing the polycarboxylic acid copolymer of the present invention and a detergent additive other than the copolymer. The composition is preferably a liquid detergent composition.

The present invention also relates to a method of producing a liquid detergent composition. The method includes adding the polycarboxylic acid copolymer to a detergent additive other than the copolymer.

The detergent additive other than the polycarboxylic acid copolymer of the present invention may be any surfactant or any additive commonly used in detergents. The detergent additive may be selected by appropriately referring to common knowledge in the detergent field.

The surfactant is preferably one or more surfactants selected from the group consisting of anionic surfactants, nonionic surfactants, cationic surfactants, and amphoteric surfactants.

Suitable examples of the anionic surfactants include alkylbenzene sulfonates, alkyl ether sulfates, alkenyl ether sulfates, alkyl sulfates, alkenyl sulfates, α-olefin sulfonates, and α-sulfonated fatty acids and ester salts thereof, alkane sulfonates, saturated fatty acid salts, unsaturated fatty acid salts, alkyl ether carboxylates, alkenyl ether carboxylates, amino acid-type surfactants, N-acylamino acid-type surfactants, and alkyl phosphoric acid esters and salts thereof, and alkenyl phosphoric acid esters and salts thereof. The alkyl group or alkenyl group of any of these anionic surfactants may contain an alkyl group such as a methyl group as a branch.

Suitable examples of the nonionic surfactants include polyoxyalkylene alkyl ethers, polyoxyalkylene alkenyl ethers, polyoxyethylene alkylphenyl ethers, higher fatty acid alkanolamides and adducts thereof with an alkylene oxide, sucrose fatty acid esters, alkyl glycoxides, fatty acid glycerol monoesters, and alkylamine oxides. The alkyl group or alkenyl group of any of these nonionic surfactants may contain an alkyl group such as a methyl group as a branch.

Suitable examples of the cationic surfactants include quaternary ammonium salts. Suitable examples of the amphoteric surfactants include carboxyl-type amphoteric surfactants and sulfobetaine-type amphoteric surfactants. The alkyl group or alkenyl group of any of these cationic surfactants and amphoteric surfactants may contain an alkyl group such as a methyl group as a branch.

The surfactant is typically present in a proportion of 10 to 80% by mass, preferably 15 to 75% by mass, more preferably 18 to 70% by mass, particularly preferably 20 to 68% by mass of the whole amount of the detergent composition. With too small a proportion of the surfactant, sufficient detergency may not be achieved, whereas with too large a proportion of the surfactant, economic efficiency may be low.

### EXAMPLES

The present invention is described in more detail below with reference to examples, but the present invention is not limited to these examples. It should be noted that the terms “part(s)” and “%” refer to “part(s) by mass” and “% by mass”, respectively, unless otherwise stated.

<Measurement Conditions of Weight Average Molecular Weight (Mw)>

The weight average molecular weight and molecular weight distribution were measured under the following measurement conditions.

Device: Waters Alliance (2695)

Analysis software: Empower professional+GPC option (Waters)

Column: TSK guard column (inner diameter: 6.0 mm×40 mm)+TSKgel G4000SWXL (inner diameter: 7.8 mm×300 mm)+G3000SWXL (inner diameter: 7.8 mm×300 mm)+G2000SWXL (inner diameter: 7.8 mm×300 mm) (TOSOH Corporation)

Detector: Differential refractive index (RI) detector (2414, Waters), photodiode array (PDA) detector (2996, Waters)

Eluent: Solution prepared by dissolving 115.6 g of sodium acetate trihydrate to a solvent mixture of 10999 g of water and 6001 g of acetonitrile, with the pH thereof adjusted to 6.0 with acetic acid.

GPC standard sample: polyethylene glycol (GL Sciences Inc.) having peak-top molecular weights (Mp) of 272500, 219300, 107000, 50000, 24000, 11840, 6450, 4250, and 1470

Calibration curve: drawn using a cubic equation based on the Mp value of the polyethylene glycol

Flow rate: 1.0 mL/min

Column temperature: 40° C.

Measuring temperature: 40° C.

Measuring time: 45 minutes

Amount of liquid sample supplied: 100 μL (eluent solution having a sample concentration of 0.5% by mass)

Amount of standard sample supplied: 100 μL (eluent solution having a sample concentration of 0.1% by mass)

<Method of Measuring Surface Tension>

A surface tension was measured under the following measurement conditions.

Device: Eko Instruments Co., Ltd.

First, 6.92 g of PELEX G-65 (Kao Corporation, active ingredient: 65%) and 4.5 g of EMULGEN 108 (Kao Corporation, active ingredient: 100%) as surfactants were weighed in a beaker, and then were diluted with ion exchange water to prepare 300 g of a surfactant solution.

To a 0.417 g portion of the surfactant solution was added 0.125 g of a polymer solution having an active ingredient concentration of 1% prepared by dilution (in Comparative Example 1, ion exchange water was added). The resulting solution was diluted with ion exchange water to 50 g in total.

The solution was allowed to stand at 25° C. for two hours. The surface tension thereof was measured with a dynamic surface tensiometer and evaluated by the following criteria.

Surface tension of lower than 35.99: Good

Surface tension of 35.99 or higher: Poor

With a surface tension of lower than 35.99, adsorption of the surfactant to stains or penetration of cleaning water into cloth was enhanced to increase the cleaning power.

The copolymer of the present invention containing structural units derived from two polyalkylene glycol monomers having different average polyalkylene glycol chain lengths effectively acts to arrange the surfactant at the air interface, increasing the adsorption amount of the surfactant and decreasing the surface tension.

<Evaluation of Miscibility with Surfactant>

First, 50 g of EMAL (registered trademark) 20C (Kao Corporation) and 7.14 g of AMPHITOL (registered trademark) 20N (Kao Corporation) as surfactants were mixed to prepare a surfactant solution.

Then, a polymer solution was added to 10 g of the surfactant solution so that the percentage of the polymer (pure content) reached 5% relative to 100% of the solid content (pure content) of the surfactant solution. The appearance of the resulting solution was observed, and the miscibility was evaluated by the following criteria.

Good: transparent

Poor: turbid or precipitated

### Example 1

A glass reactor equipped with a thermometer, a stirrer, a dropping device, a nitrogen inlet tube, and a reflux condenser was charged with 140 parts of water. The reaction vessel was heated to 80° C. while being purged with nitrogen under stirring at 200 rpm. An aqueous monomer solution containing a mixture of 79.3 parts of methoxypolyethylene glycol monomethacrylate (average number of moles of ethylene oxide added: 6, hereinafter, also referred to as PGM6E), 69.8 parts of methoxypolyethylene glycol monomethacrylate (average number of moles of ethylene oxide added: 25, hereinafter, also referred to as PGM25E), 32.8 parts of methacrylic acid (hereinafter, also referred to as MAA), 2.16 parts of sodium methacrylate (hereinafter, also referred to as SMAA), 61.3 parts of water, and 1.80 parts of 3-mercaptopropionic acid (hereinafter, also referred to as MPA) as a chain transfer agent and an aqueous solution containing a mixture of 1.66 parts of ammonium persulfate (hereinafter, also referred to as APS) and 11.2 parts of water were added dropwise over four hours and over five hours, respectively, from the same start time. After the dropwise addition, the temperature was maintained at 80° C. for another hour to complete the polymerization reaction. Thus, an aqueous solution of a copolymer (1) having a weight average molecular weight of 19,200 was obtained.

### Example 2

A glass reactor equipped with a thermometer, a stirrer, a dropping device, a nitrogen inlet tube, and a reflux condenser was charged with 140 parts of water. The reaction vessel was heated to 80° C. while being purged with nitrogen under stirring at 200 rpm. An aqueous monomer solution containing a mixture of 74.1 parts of PGM6E, 65.1 parts of PGM25E, 42.0 parts of MAA, 2.77 parts of SMAA, 61.3 parts of water, and 2.05 parts of MPA as a chain transfer agent and an aqueous solution containing a mixture of 1.66 parts of APS and 11.0 parts of water were added dropwise over four hours and over five hours, respectively, from the same start time. After the dropwise addition, the temperature was maintained at 80° C. for another hour to complete the polymerization reaction. Thus, an aqueous solution of a copolymer (2) having a weight average molecular weight of 18,100 was obtained.

### Example 3

A glass reactor equipped with a thermometer, a stirrer, a dropping device, a nitrogen inlet tube, and a reflux condenser was charged with 140 parts of water. The reaction vessel was heated to 80° C. while being purged with nitrogen under stirring at 200 rpm. An aqueous monomer solution containing a mixture of 68.3 parts of PGM6E, 60.0 parts of PGM25E, 52.3 parts of MAA, 3.45 parts of SMAA, 61.3 parts of water, and 2.33 parts of MPA as a chain transfer agent and an aqueous solution containing a mixture of 1.66 parts of APS and 10.7 parts of water were added dropwise over four hours and over five hours, respectively, from the same start time. After the dropwise addition, the temperature was maintained at 80° C. for another hour to complete the polymerization reaction. Thus, an aqueous solution of a copolymer (3) having a weight average molecular weight of 16,600 was obtained.

### Example 4

A glass reactor equipped with a thermometer, a stirrer, a dropping device, a nitrogen inlet tube, and a reflux condenser was charged with 140 parts of water. The reaction vessel was heated to 80° C. while being purged with nitrogen under stirring at 200 rpm. An aqueous monomer solution containing a mixture of 79.3 parts of PGM6E, 69.8 parts of PGM25E, 32.8 parts of MAA, 2.16 parts of SMAA, 61.3 parts of water, and 2.94 parts of 3-mercaptopropionic acid (hereinafter, also referred to as MPA) as a chain transfer agent and an aqueous solution containing a mixture of 1.66 parts of APS and 10.1 parts of water were added dropwise over four hours and over five hours, respectively, from the same start time. After the dropwise addition, the temperature was maintained at 80° C. for another hour to complete the polymerization reaction. Thus, an aqueous solution of a copolymer (4) having a weight average molecular weight of 11,800 was obtained.

### Comparative Example 1

A glass reactor equipped with a thermometer, a stirrer, a dropping device, a nitrogen inlet tube, and a reflux condenser was charged with 128.3 parts of water, and was heated to 80° C. under stirring at 200 rpm. An aqueous monomer solution containing a mixture of 120.1 parts of PGM25E, 51.1 parts of MAA, 40.3 parts of water, and 5.2 parts of MPA as a chain transfer agent was added dropwise over three hours, and 54 parts of 4% APS was added dropwise over 3.5 hours. After the dropwise addition, the temperature was maintained at 80° C. for another half-hour to complete the polymerization reaction. After the polymerization, a 48% NaOH aqueous solution was added. Thus, an aqueous solution of a comparative copolymer (1) having a weight average molecular weight of 23,800 was obtained.

The copolymers of Examples 1 to 4 and Comparative Example 1 were subjected to evaluation of the miscibility with surfactants and the surface tension. In Comparative Example 2, evaluation was performed without addition of any copolymer. The results are show in Table 1.

TABLE 1

| | | Composition ratio of monomers | Weight average | | Surface |
|---|---|---|---|---|---|
| | Polymer | (% by mass) | molecular weight | Miscibility | tension |
| Example 1 | Copolymer (1) | PGM25E/PGM6E/MAA = 38/43.2/18.8 | 19200 | Good | Good |
| Example 2 | Copolymer (2) | PGM25E/PGM6E/MAA = 36/40/24 | 18100 | Good | Good |
| Example 3 | Copolymer (3) | PGM25E/PGM6E/MAA = 33/37/30 | 16600 | Good | Good |
| Example 4 | Copolymer (4) | PGM25E/PGM6E/MAA = 38/43.2/18.8 | 11800 | Good | Good |
| Comparative | Comparative | PGM25E/MAA = 70/30 | 23800 | Good | Poor |
| Example 1 | copolymer (1) | | | | |
| Comparative | — | — | — | Good | Poor |
| Example 2 | | | | | |

1. A polycarboxylic acid copolymer used in liquid detergent applications, the polycarboxylic acid copolymer comprising:
a structural unit (a) derived from a polyalkylene glycol monomer (A) represented by the following formula (1): 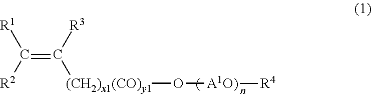
wherein R¹, R², and R³ are the same as or different from each other and are each a hydrogen atom or a methyl group; R⁴ is a hydrogen atom or a C1-C30 hydrocarbon group; A¹Os are the same as or different from each other and are each an oxyalkylene group; n is the average number of moles of oxyalkylene groups added and is a number of 4 to 100; x1 is a number of 0 to 4; and y1 is 0 or 1;
a structural unit (b) derived from a polyalkylene glycol monomer (B) represented by the following formula (2): 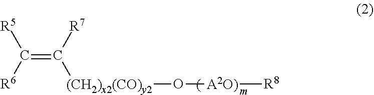
wherein R⁵, R⁶, and R⁷ are the same as or different from each other and are each a hydrogen atom or a methyl group; R⁸ is a hydrogen atom or a C1-C30 hydrocarbon group; A²Os are the same as or different from each other and are each an oxyalkylene group; m is the average number of moles of oxyalkylene groups added and is a number of 1 to 97; x2 is a number of 0 to 4; and y2 is 0 or 1; and
a structural unit (c) derived from an unsaturated carboxylic acid monomer (C),
the monomers (A) and (B) satisfying n−m≥3.

2. The polycarboxylic acid copolymer according to claim 1,
wherein the structural unit (c) is present in a proportion of 18 to 50% by mass based on 100% by mass of all structural units.

3. The polycarboxylic acid copolymer according to claim 1 or 2,
wherein the unsaturated carboxylic acid monomer (C) is (meth)acrylic acid or a salt thereof, maleic acid or a salt thereof, or maleic anhydride.

4. The polycarboxylic acid copolymer according to claim 1,
wherein n in the formula (1) for the monomer (A) is 5 to 100.

5. The polycarboxylic acid copolymer according to claim 1,
wherein m in the formula (2) for the monomer (B) is 2 to 97.

6. An additive for liquid detergents, comprising the polycarboxylic acid copolymer according to claim 1.

7. A liquid detergent composition comprising:
the polycarboxylic acid copolymer according to claim 1; and
a detergent additive other than the copolymer.

8. A method of producing a liquid detergent composition,
the method comprising adding the polycarboxylic acid copolymer according to claim 1 to a detergent additive other than the copolymer.

9. A method of using a polycarboxylic acid copolymer,
the method comprising adding the polycarboxylic acid copolymer according to claim 1 to a liquid detergent.
